(19) United States
(12) Patent Application Publication
(10) Pub. No.: US 2025/0342355 A1
(43) Pub. Date: Nov. 6, 2025

(54) CONTRASTIVE LEARNING USING POSITIVE PSEUDO LABELS

(71) Applicant: DeepMind Technologies Limited, London (GB)

(72) Inventors: Jovana Mitrovic, London (GB); Matko Bosnjak, London (GB); Pierre Richemond, London (GB); Nenad Tomasev, London (GB); Florian Strub, Paris (EP); Jacob Charles Walker, London (GB); Felix George Hill, London (GB); Lars Buesing, Letchworth Garden City (GB); Razvan Pascanu, Letchworth Garden City (GB); Charles Blundell, London (GB)

(21) Appl. No.: 18/867,073

(22) PCT Filed: May 19, 2023
(86) PCT No.: PCT/EP2023/063496

§ 371 Date: Nov. 19, 2024

Related U.S. Application Data
(60) Provisional application No. 63/344,026, filed on May 19, 2022.

(51) Int. Cl. G06N 3/08

(52) U.S. Cl. CPC G06N 3/08

(57) ABSTRACT

Methods, systems, and apparatus, including computer programs encoded on a computer storage medium, for training a neural network to perform a machine learning task on one or more received inputs by using a hybrid training dataset with a semi-supervised learning technique. The hybrid training dataset includes multiple unlabeled training inputs and multiple labeled training inputs and, in some cases, more unlabeled training inputs than labeled training inputs.

### CROSS-REFERENCE TO RELATED APPLICATION

This application claims priority to U.S. Provisional Application No. 63/344,026, filed on May 19, 2022. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that implements and trains a neural network by using a semi-supervised learning technique with both labeled and unlabeled data. Once trained, the neural network can perform a machine learning task on one or more received inputs.

According to an aspect, there is provided a computer-implemented method comprising: obtaining a batch of training inputs from a hybrid training dataset, wherein the batch of training inputs comprises one or more unlabeled training inputs and one or more labeled training inputs, each labeled training input having a respective ground truth label; generating a respective first augmented view of each training input in the batch; processing, using an online neural network and in accordance with online network parameter values, the respective first augmented view of each training input to generate a respective online embedding of the training input; generating a respective second augmented view of each training input in the batch, wherein, for each training input in the batch, the respective second augmented view is different from the respective first augmented view; processing, using a target neural network and in accordance with target network parameter values, the respective second augmented view of each training input to generate a respective target embedding of the training input; updating a queue of embeddings to include respective target embeddings generated by using the target neural network for the one or more labeled training inputs in the batch; generating, for each of the one or more unlabeled training inputs in the batch, a pseudo label based on a measure of similarity between an online embedding of the unlabeled training input and each respective target embedding in the queue of embeddings; determining, for each training input in the batch, a respective semantic positive sample, comprising sampling, from the queue of embeddings and as the semantic positive sample, an embedding that has been generated for a labeled training input having the same pseudo label or the same ground truth label as the training input; determining a gradient with respect to the online network parameter values of a loss function that includes a first term that encourages similarity between the respective online embedding and the respective semantic positive sample for each training input; and determining, based on the gradient of the loss function with respect to the online network parameter values, an update to the online network parameter values.

The loss function may include a second term that encourages similarity between the respective online and target embeddings for each training input.

The online neural network may comprise an online projection sub neural network and an online prediction sub neural network, the online projection sub neural network and the target neural network having a same network architecture but different parameter values.

The target network parameter values may be an exponential moving average of online projection sub network parameter values of the online projection sub neural network. The queue of embeddings may have a fixed capacity which is dependent on a size of the batch of training inputs.

The queue of embeddings may include respective target embeddings generated by using the target neural network for one or more labeled training inputs in a previously obtained batch.

The training inputs may comprise image data.

The training inputs may comprise audio data.

Generating the respective first augmented view of each training input in the batch may comprise: sampling one or more augmentation policies from a set of augmentation policies; and sequentially applying the one or more sampled augmentation policies to each training input in the batch.

The set of augmentation policies may comprise a random cropping policy followed by resizing policy, a random color distortion policy, or a random Gaussian blur policy.

Generating, for each of the one or more unlabeled training inputs in the batch, the pseudo label may comprises: using a k-nearest neighbors model to determine k nearest embeddings of the unlabeled training input from the queue of embeddings, where k is a positive integer; and generating the pseudo label for the unlabeled training input from the ground truth labels associated with the k nearest embeddings.

In some cases, k=1, and the pseudo label may be the same as the ground truth label associated with the determined nearest embedding.

In some cases, k>=2, and the pseudo label may be a highest occurring ground truth label among the determined nearest embeddings.

The k-nearest neighbors model may be configured to use cosine similarity to determine the k nearest embeddings of each unlabeled training input.

Generating, for each of the one or more unlabeled training inputs in the batch, the pseudo label may comprise: selecting, from among multiple k-nearest neighbors models that each correspond to a different augmentation policy, one or more k-nearest neighbors models; and using each selected k-nearest neighbors model to determine k nearest embeddings of the unlabeled training input from the queue of embeddings.

The hybrid training dataset may comprise more unlabeled training inputs than labeled training inputs.

The method may further comprise training a task sub neural network together with the online projection sub neural network to optimize a supervised, task-specific loss for a downstream task, wherein, for a training input from the hybrid training dataset, the task sub neural network may be configured to process a projection embedding generated by the online projection sub neural network in accordance with task sub network parameter values to generate a downstream task output for the training input.

The downstream task may comprise a classification task, and wherein the supervised, task-specific loss may comprise a cross-entropy loss.

According to another aspect, there is provided one or more computer-readable storage media encoded with instructions that, when executed by one or more computers, cause the one or more computers to perform the operations of the above method aspect.

According to yet another aspect, there is provided a system comprising one or more computers and one or more storage devices storing instructions that when executed by one or more computers cause the one or more computers to perform the respective operations of the above method aspect.

According to a further aspect, there is provided a method comprising: receiving a network input; and processing the network input using a neural network comprising an online projection sub neural network and a task sub neural network trained by the method of any above aspect to generate one or more network outputs for the network input, comprising: processing the network input using the online projection sub neural network to generate a projection embedding; and processing the projection embedding using the task sub neural network to generate the one or more network outputs.

It will be appreciated that features described in the context of one aspect may be combined with features described in the context of another aspect.

The subject matter described in this specification can be implemented in particular embodiments so as to realize one or more of the following advantages. The system as described in this specification pre-trains a neural network by using a semi-supervised learning technique that effectively combines labeled and unlabeled data to generate informative representations that may later be useful in a specific downstream task. The system uses a relatively small amount of labeled data to impute the pseudo label information for a vastly larger amount of unlabeled data, and subsequently incorporates the imputed pseudo label information into a contrastive learning scheme to train the neural network to generate similar representations for each pair of training inputs having the same ground truth or pseudo labels. In particular, unlike many existing semi-supervised learning techniques which use the available label information as supervision within a cross-entropy objective, the described system uses this label information to determine which training inputs should have similar representations.

Further, the pre-trained neural network can then be used to effectively adapt to a specific machine learning task using orders of magnitude less data than was used to pre-train the network. For example, while pre-training the network may utilize billions of unlabeled training inputs, adapting the network for a specific task may require merely a few thousand labeled training inputs. Compared with other conventional training approaches, the system can thus make more efficient use of computational resources, e.g., processor cycles, memory, or both during training. The system can also train the neural network using orders of magnitude smaller amount of labeled data and, correspondingly, at orders of magnitude lower human labor cost associated with data labeling, while still ensuring a competitive performance of the trained neural network on a range of tasks that match or even exceed the state-of-the-art while additionally being generalizable and easily adaptable to new tasks.

Pre-training large neural networks that can be used for real-world tasks generally results in significant carbon dioxide (CO₂) emissions and a significant amount of electricity usage. By decreasing the number of FLOPs required to be performed and performing fewer training iterations for the reasons described above, the described techniques significantly reduce the CO₂ footprint of the pre-training process while also significantly reducing the amount of electricity consumed by the pre-training process.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 is an example illustration of a semantic positives via pseudo-labels (SEMPPL) training process.

FIG. 3 is a flow diagram of an example process for training an online neural network.

FIG. 4 shows a quantitative example of the performance gains that can be achieved by using the SEMPPL process described in this specification.

Like reference numbers and designations in the various drawings indicate like elements.

### DETAILED DESCRIPTION

This specification describes a system implemented as computer programs on one or more computers in one or more locations that implements and trains a neural network that can perform a machine learning task on one or more received inputs. Depending on the task, the neural network can be configured to receive any kind of digital data input and to generate any kind of score, classification, or regression output based on the input.

For example, the neural network can be configured to perform an image processing task, e.g., to receive an input comprising image data which includes a plurality of pixels. The image data may for example comprise one or more images or features that have been extracted from one or more images. The neural network can be configured to process the image data to generate an output for the image processing task.

For example, if the task is image classification, the outputs generated by the neural network for a given image may be scores for each of a set of object categories, with each score representing an estimated likelihood that the image contains an image of an object belonging to the category.

As another example, if the task is object detection, the outputs generated by the neural network for a given image may be one or more bounding boxes each associated with respective scores, with each bounding box representing an estimated location in the image and the respective score representing an estimated likelihood that an object is depicted at the location in the image, i.e., within the bounding box.

As another example, if the task is semantic segmentation, the outputs generated by the neural network for a given image may be labels for each of a plurality of pixels in the image, with each pixel being labeled as belonging to one of a set of object categories. Alternatively, the outputs can be, for each of the plurality of pixels, a set of scores that includes a respective score for each of the set of object categories that represents the likelihood that the pixel belongs to an object from the object category.

As another example, if the inputs to the neural network are Internet resources (e.g., web pages), documents, or portions of documents or features extracted from Internet resources, documents, or portions of documents, the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is a sequence of observations or other data characterizing states of an environment (such as a real-world or simulated environment) and the output defines an action to be performed by the agent in response to the most recent data in the sequence. The agent can be, e.g., a real-world or simulated robot, a control system for an industrial facility (e.g. a temperature control system for the facility, or a system which partitions tasks among units of the facility), or a control system that controls a different kind of agent. The observations may be the outputs of sensors (e.g. cameras) monitoring the environment.

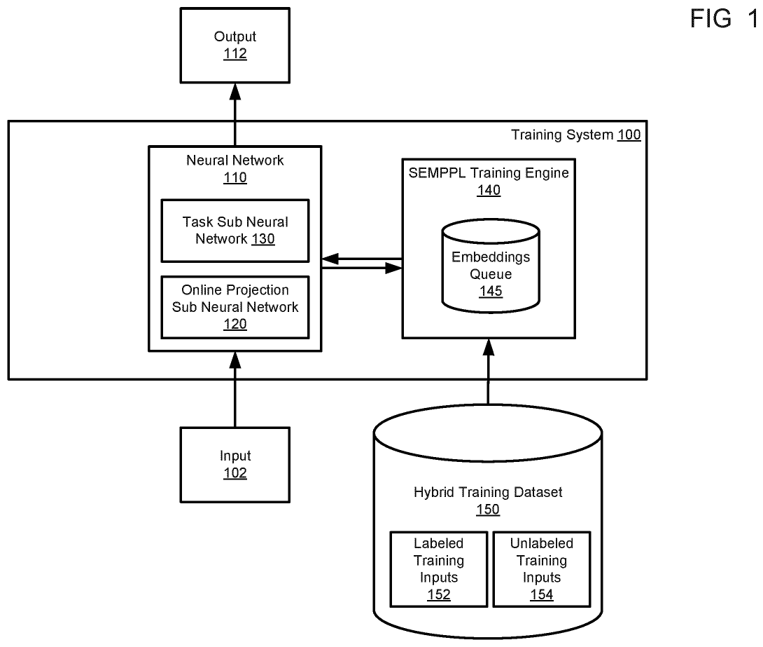

FIG. 1 shows an example training system 100. The training system 100 is an example of a system implemented as computer programs on one or more computers in one or more locations, in which the systems, components, and techniques described below are implemented.

The training system 100 includes a neural network 110 and a semantic positives via pseudo-labels (SEMPPL) training engine 120, or “training engine” for short. The neural network 110 is configured to receive an input 102 and generate one or more outputs 112 based on the received input 102 and on values of the network parameters of the neural network 110.

At a high level, the neural network 110 includes an online projection sub neural network 120 and a task sub neural network 130. During each forward pass for inference computation, the online projection sub neural network 120 processes the input 102 to generate a projection embedding, which is then received and processed by the task sub neural network 130 to generate the one or more network outputs 112. An embedding refers to an ordered collection of numerical values, e.g., a vector, matrix, or other tensor of numerical values.

A sub neural network of a neural network refers to a group of one or more neural network layers in the neural network. Each sub neural network can be implemented with any appropriate neural network architecture that enables it to perform its described function. A projection embedding means an embedding produced by successively applying the functions of the successive layer(s) of the sub neural network 120 to the input 102.

In some examples, when the input 102 to the neural network 110 includes images, the online projection sub neural network 120 can be a convolutional sub neural network, i.e., that includes one or more convolutional layers, that is configured to process the image to generate an embedding for the image. When the input 102 includes text data or other lower- dimensional data, the online projection sub neural network 120 can additionally or alternatively include one or more fully-connected layers. The task sub neural network 130 can include one or more output layers that are configured to process the embedding to generate the output. For example, when the task is a classification task, the task sub neural network 130 can include one or more fully-connected layers followed by a softmax layer that generates a score distribution over a set of categories. As another example, when the task is a regression task, the task sub neural network 130 can include one or more linear layer that generate the output value(s).

Before the neural network 110 can be used to perform any of the tasks, the training engine 140 of the training system 100 trains the neural network 110 on a hybrid training dataset 150, i.e., so that the neural network 110 can effectively perform the task on new data.

A hybrid training dataset 150 is a dataset which includes both labeled training inputs 152 for which known, ground truth labels, e.g., a ground truth classification of a training input, that should be generated by the neural network 110 are available to the training system 100, and unlabeled training inputs 154 for which no known, ground truth labels are available. In various cases, the training inputs (either labeled 152 or unlabeled 154) can be or include image data, audio data, textual data, or some combination thereof. In various cases, because unlabeled training data is relatively more easily obtainable in massive volumes across a wide range of tasks, i.e., compared with labeled (e.g., human or machine annotated) training data, the hybrid training dataset 150 will include more, sometimes multiple times more, unlabeled training inputs 154 than labeled training inputs 152.

By leveraging a semi-supervised learning technique (a “semantic positives via pseudo-labels” or “SEMPPL” technique) and the abundance of the unlabeled training data, the training engine 140 of the training system 100 pre-trains the online projection sub neural network 120 on the hybrid training dataset 150 to determine trained parameter values of the online projection sub neural network 120. The purpose of the pre-training process may be viewed as learning to generate meaningful embeddings that could be useful in a wide range of downstream tasks and to make the adaptation of a larger neural network 110 having the online projection sub neural network 120 to a particular downstream task faster and more computing resource efficient.

In particular, by maintaining a queue of embeddings 145 generated from the labeled training inputs 152 during the pre-training stage, the training engine 140 is able to select one or more similar embeddings from the queue for an unlabeled training input and correspondingly use the ground truth labels of the selected similar embeddings to generate a pseudo label for the unlabeled training input. The selection of similar embeddings includes querying the queue of embeddings 145 using a k-nearest neighbor (“k-NN”) algorithm or a similar technique. In this way, the training engine 140 ensures that any training input from the hybrid training dataset 150 is labeled, i.e., either has an already available ground truth label, or has an imputed pseudo label.

After the pre-training has completed, the pre-trained online projection sub neural network 120 may be adapted for a downstream task. The downstream task can be any of the tasks mentioned above. In particular, the training system 100 may train the online projection sub neural network 120 together with the task sub neural network 130, which in some cases is an untrained neural network, e.g., a neural network that has randomly initialized parameter values, that has not previously been trained during pre-training stage. During the adaptation process, the parameter values of the task sub neural network 130 and, in some cases, the parameter values of the online projection sub neural network 120 learned during the pre-training are adjusted so that the neural network 110 having both sub neural networks 120 and 130 is adapted to the downstream task.

The training engine 140 can adjust the parameter values based on optimizing a supervised, task-specific loss for the downstream task. In some examples, if the downstream task is a classification task, the supervised loss can be a cross-entropy loss; if the downstream task is a regression task, the supervised loss can be a mean squared error (MSE) loss function. The adaptation process can use labeled training inputs 152 within the same hybrid training dataset 150, or alternatively use a different labeled training dataset that is specifically curated for that downstream task.

Once both pre-training and adaptation processes have completed, the training system 100 can provide data specifying the trained neural network 110, e.g., the trained values of the network parameters of the online projection sub neural network 120 and the task sub neural network 130 and data specifying the architectures of sub neural networks 120 and 130, to another system, e.g., an inference system in a deployment environment, for use in processing new inputs. Instead of or in addition to providing the data specifying the trained neural network 110, the training system 100 can use the trained neural network to process new inputs 102 and generate corresponding outputs 112.

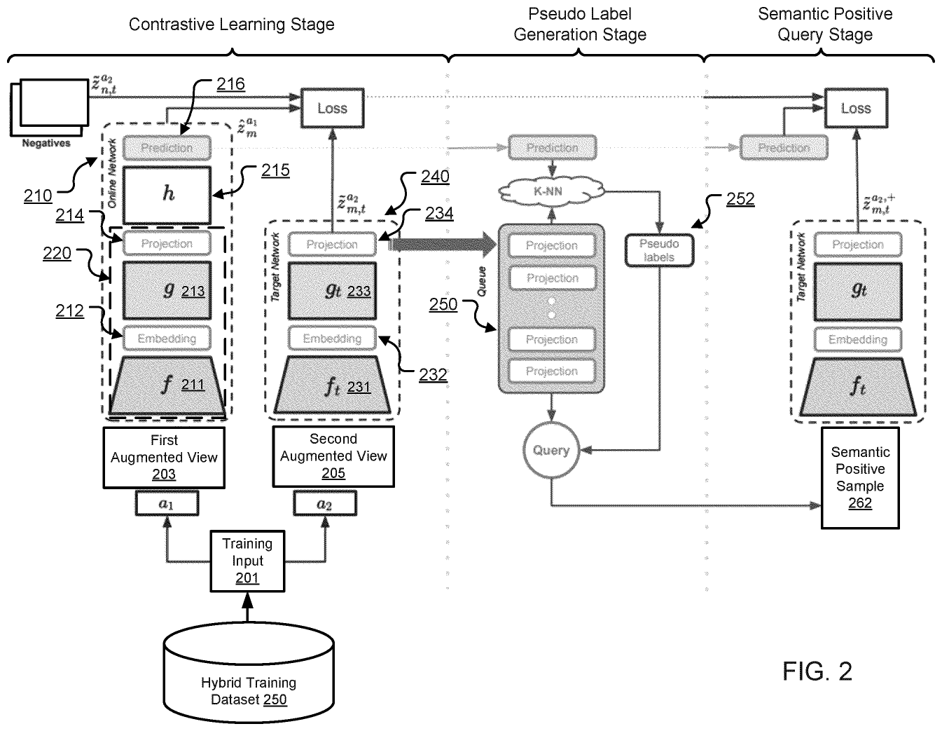

FIG. 2 is an example illustration of a semantic positives via pseudo-labels (SEMPPL) training process. In general, one iteration of this SEMPPL training process can be performed on each training input 201 within a batch of training inputs sampled from the hybrid training dataset 250. As illustrated, the SEMPPL training process includes three stages: a contrastive learning stage during which an (optional) augmentation-based contrastive learning loss term is computed, followed by a pseudo label generation stage (which is performed for each unlabeled training input), followed by a semantic positive query stage during which a semantic positive-based contrastive learning loss term is computed. After performing one SEMPPL training iteration for each training input 201 within the batch, the parameters of an online neural network can then be updated based on optimizing a SEMPPL loss function, which includes both contrastive learning loss terms that have been computed with respect to the entire batch of training inputs.

The contrastive learning stage begins with using one or more different augmentation policies to transform each training input 201 within the batch of training inputs to generate a first augmented view 203 and a second augmented view 205 of the training input 201. The training input 201 can be either labeled, or unlabeled. The specific operations to be performed to transform each training input may vary from one implementation to another, e.g., depending on the data modality of the training input 201.

By way of illustration and not limitation, when the training inputs include image data, the following set of augmentation policies can be used to transform each training input.

TABLE 1

| | |
|---|---|
| Random cropping | Crop the image at a randomly selected point, e.g., at the center |
| | or at one of the four corners |
| Random resizing | Randomly select a patch of the image, between a minimum |
| | and maximum crop area of the image, with aspect ratio |
| | sampled log-uniformly in [3/4, 4/3]. Upscale the patch, via |
| | bicubic interpolation, to a square image of size s × s |
| Horizontal flipping | — |
| Color distortion | Randomly adjust brightness, contrast, saturation and hue of |
| | the image, in a random order, uniformly by a value in [−a, a] |
| | where a is the maximum adjustment |
| Gray scaling | Combine the channels into one channel with value 0.2989r + |
| | 0.5870g + 0.1140b |
| Random blur | Apply a 23 × 23 Gaussian kernel with standard deviation |
| | sampled uniformly in [0.1, 2.0] |
| Random solarization | Threshold each channel value such that all values less than 0.5 |
| | are replaced by 0 and all values above or equal to 0.5 are |
| | replaced with 1 |
| Saliency masking | Remove at least some of the background with homogeneous |
| | grayscale noise having a randomly sampled the grayscale |
| | level |

Analogously, when the training inputs include text data, augmentation policies that can be used to transform each training input can for example include synonym replacement, random insertion, random swap, random deletion, and so on; when the training inputs include audio data, augmentation policies that can be used to transform each training input can for example include noise injection, time shifting, pitch changing, and so on.

To transform each training input 201 within a sampled batch to generate the first augmented view 203 and the second augmented view 205 of the training input, the training engine can sample a first sequence of one or more augmentation policies (“a1”) and a second sequence of one or more augmentation policies (“a2”) from the set of augmentation policies. The training engine can then sequentially apply the first sequence of one or more sampled augmentation policies within the first sequence to the training input to generate the first augmented view and apply the second sequence of one or more sampled augmentation policies within the second sequence to the training input to generate the second augmented view.

When sampled from the set of augmentation policies with at least some measure of randomness, the first and second sequences of augmentation policies, and hence, the resulting augmented views of the same training input, will usually be different from each other. For example, the first augmented view 203 is generated from the training input 201 as a result of applying a random cropping policy followed by a resizing policy followed by a random Gaussian blur policy, while the second augmented view 205 is generated from the training input 201 as a result of applying a random cropping policy followed by a random color distortion policy followed by a random solarization policy.

For each training input 201 within the sampled batch, the training engine provides the first augmented view 203 of the training input as input to the online neural network 210. As illustrated in FIG. 2, the online neural network 210 includes an online projection sub neural network 220 and an online prediction sub neural network 215. The online projection sub neural network 220, in turn, includes an encoder backbone 211 and a projector head 213.

The online neural network 210 processes, in accordance with the current values of the parameters of the online neural network (“online network parameter values”), the first augmented view 203 to generate an online embedding 216 of the training input 201.

Specifically, the online neural network 210 first uses the encoder backbone 211 to encode the first augmented view 203 into an encoded embedding 212, then uses the projector head 213 to project the encoded embedding 212 into a projection embedding space to generate a projection embedding 214, and finally uses the online prediction sub neural network 215 to process the projection embedding 214 to generate the online embedding 216. In some implementations, the output of the online prediction sub neural network 215 is directly used as the online embedding 216 while in other implementations, the online embedding 216 is a further transformed, e.g., L-2 normalized, output of the online prediction sub neural network 215.

For each training input 201 within the sampled batch, the training engine provides the second augmented view 205 of the training input as input to the target neural network 240, which is another instance of the online projection sub neural network 220 that is used to assist in the SEMPPL training process. Thus, as illustrated in FIG. 2, the target neural network 240 includes a target encoder backbone 231 and a target projector head 233.

In particular, the target neural network 240 has the same network architecture but, at at least some points during the training, different parameter values than the online projection sub neural network 220.

The training engine can make the values of the parameters of the target neural network 240 (“the target network parameter values”) different from the online projection sub network parameter values in any of a variety of ways.

For example, the training engine uses the target neural network 240 to mimic the online projection sub neural network 220 in that, at intervals, online projection sub network parameter values from the online projection sub neural network 220 are copied across to the target neural network 240.

As another example, the training engine can make the target network parameter values to be an exponential moving average of online projection sub network parameter values of the online projection sub neural network 220. That is, rather than copying the online projection sub network parameter values to the target neural network, the target network parameter values slowly track the online projection sub network parameter values according to θ′←τθ+(1−τ)θ′ where θ′ denotes the target network parameter values and θ denotes the online projection sub network parameter values and τ<1.

The target neural network 240 processes, in accordance with the target network parameter values, the second augmented view 205 to generate a target embedding 234 of the training input 201. Specifically, the target neural network 240 first uses the target encoder backbone 231 to encode the second augmented view 205 into an encoded embedding 232, then uses the target projector head 233 to project the encoded embedding 232 into a projection embedding space to generate the target embedding 234. Like the online neural network 210, in some implementations, the output of the target sub neural network 240 is directly used as the target embedding 234 while in other implementations, the target embedding 234 is the further transformed, e.g., L-2 normalized, output of the target sub neural network 240.

The augmentation-based contrastive learning loss term, which is optionally used by the system, can now be calculated. For each training input 201, this loss term encourages similarity—i.e., reduces the distance in the embedding space-between the online embedding 216 and the target embedding 234 that have been generated by the online neural network 210 and the target neural network 240, respectively. As described above, the two embeddings have been generated from different augmented views 203 and 205 of each training input 201, where each augmented view is generated by applying different data augmentation policies to the training input.

On the other hand, this loss term encourages dissimilarity—i.e., increases the distance in the embedding space—between the online embedding 216 and the target embedding 234 that have been generated by the online neural network 210 and the target neural network 240 from the training input 201 and any other training input within the batch different (that is different than the training input 201), respectively.

The augmentation-based contrastive learning loss term thus trains the encoder backbone 211 of the online neural network 210 to generate similar embeddings (that are close to each other in the embedding space) for a pair of different augmented views of the same training input, and to generate distinct embeddings (that are apart from each other in the embedding space) for different training inputs.

The augmentation-based contrastive learning loss term, when used, can for example be computed as:

$${ℒ}_{AUGM} = - {\sum }_{m = 1}^{B} log \frac{φ ( {\hat{z}}_{m}^{{a}_{1}} , {\tilde{z}}_{m , t}^{{a}_{2}} )}{φ ( {\hat{z}}_{m}^{{a}_{1}} , {\tilde{z}}_{m , t}^{{a}_{m}} ) + {( {x}_{m} )}_{} φ ( {\hat{z}}_{m}^{{a}_{1}} , {\tilde{z}}_{n , t}^{{a}_{m}} )} ,$$

where B represents the batch of training inputs x₁-xₘ; φ(x₁,x₂)=τ·exp(<x₁,x₂>/τ) is the scoring function, τ>0 is a scalar temperature and <·,·>denotes the Euclidean dot product;

$${\hat{z}}_{m}^{{a}_{1}} = h ( g ( f ( {x}_{m}^{{a}_{1}} ) ) )$$

is the online embedding (the hat operator indicates that it's L-2 normalized), where h denotes the parameters of the online prediction sub neural network, g denotes the parameters of the projector head, and f denotes the parameters of the encoder backbone of the online neural network;

$${\hat{z}}_{m , t}^{{a}_{2}} = {g}_{t} ( {f}_{t} ( {x}_{m}^{{a}_{2}} ) )$$

is the target embedding, where gₜ denotes the parameters of the target projector head, and fₜ denotes the parameters of the target encoder backbone of the target neural network; [symbol] (xₖ) is the set of negative samples (different training inputs randomly sampled from the same batch), and

$${\tilde{z}}_{n , t}^{{a}_{2}} = {g}_{t} ( {f}_{t} ( {x}_{n} ) )$$

is the target embedding generated by the target neural network for each such negative sample.

Moreover, if the training input 201 is a labeled training input, the training engine will update a first-in-first-out (FIFO) queue 250 to include (a copy of) the target embedding 234 of the training input 201. In this way, the FIFO queue 250, which will be accessed during the subsequent stages of the SEMPPL training iteration, stores the target embeddings have been generated by using the target neural network 240 for the one or more labeled training inputs within the batch. Although logically described as a first-in-first-out (FIFO) queue, it will be appreciated that any another type of data structure (e.g., buffer or list) can be used.

At the beginning of the SEMPPL training, the FIFO queue 250 can be initialized with random vectors. And then for each subsequent SEMPPL training iteration, the target embeddings that are generated by using the target neural network 240 for the labeled training inputs within the batch of training inputs sampled for the SEMPPL training iteration will be appended to the FIFO queue 250.

The FIFO queue 250 of embeddings in the example of FIG. 2 can have a fixed capacity C , which is usually dependent on a size B of the batch of training inputs. For example, the capacity C can be set to be no smaller than size B of the batch of training inputs, such that the queue 250 is capable of storing not only the target embeddings generated for the labeled training inputs within the currently sampled batch, but also the target embeddings generated for the labeled training inputs within one or more previously sampled batches. For example, C=10B, or 20B, where B=2048, 4096 or the like. As the amount and diversity of the available target embeddings increase, the training effectiveness may also be improved.

Proceeding now to the pseudo label generation stage, the training engine accesses the FIFO queue 250 of target embeddings to generate the pseudo label 252 for each of the one or more unlabeled training inputs within the batch.

In particular, for each unlabeled training input, the training engine can do this by using a k-nearest neighbors algorithm (“k-NN”) or a similar technique (e.g., a support vector machine (SVM), a random forest technique, etc.) to identify, from among this FIFO queue 250 of target embeddings, k nearest embeddings (with k being a positive integer) that are most similar to an online embedding that has been generated by the online neural network from the unlabeled training input, and then generating the pseudo label 252 for the unlabeled training input from the ground truth label(s) associated with the k nearest embeddings. Here, the “similarity” is defined in terms of a distance in an embedding space. The distance can be computed in any appropriate way, such as with Euclidean distance, Hamming distance, cosine similarity, to name just a few examples.

Depending on the exact number of nearest embeddings that is being selected, the training engine can generating the pseudo label 252 for the unlabeled training input in any of a variety of ways. For example, when k=1, the pseudo label can be the same as the ground truth label associated with the single determined nearest embedding; when k>=2, the pseudo label 252 can be the highest occurring ground truth label among the multiple determined nearest embeddings.

Moreover, some implementations of the system can maintain multiple k-nearest neighbors models that each correspond to a different augmentation policy. Accordingly, the training engine first selects, from among the multiple k-nearest neighbors models, a k-nearest neighbors model for each augmentation policy that was used to transform the unlabeled training input, and then uses each selected k-nearest neighbors model to determine k nearest embeddings of the unlabeled training input from the FIFO queue 250 of target embeddings. In these implementations, the pseudo label 252 can similarly be the highest occurring ground truth label among all of the nearest embeddings collectively selected by the multiple k-nearest neighbors models.

Proceeding now to the semantic positive query stage (during which the pseudo labels will be used), the training engine determines a respective semantic positive sample 262 for each training input within the batch. In particular, unlike the pseudo label generation stage in which pseudo labels are generated for just the unlabeled training inputs, at the semantic positive query stage, the semantic positive samples are determined for the entire batch of training inputs.

For each training input 201 within the batch, the training engine uniformly and randomly samples, from among the FIFO queue 250 of target embeddings, and as the semantic positive sample 262, an embedding that has been generated for a labeled training input having the same label as the training input 201. That is, if the training input 201 is a labeled training input, then an embedding that has been generated for a labeled training input having the same ground truth label as the training input 201 will be selected; alternatively, if the training input 201 is an unlabeled training input, then an embedding that has been generated for a labeled training input having the same pseudo label as the training input 201 will be selected.

The semantic positive-based contrastive learning loss term can now be calculated. For each training input 201, this loss term encourages similarity—i.e., reduces the distance in the embedding space—between the online embedding 216 of the training input 101 and a corresponding semantic positive sample 262 obtained from the queue 205. The semantic positive sample 262 is a target embedding that has been generated for a labeled training input having the same pseudo label or the same ground truth label as the training input 201.

On the other hand, this loss term encourages dissimilarity—i.e., increases the distance in the embedding space—between the online embedding 216 and the target embedding 234 that have been generated by the online neural network 210 and the target neural network 240 from the training input 201 and any other training input within the batch, respectively.

The semantic positive-based contrastive learning loss term thus trains the encoder backbone 211 of the online neural network 210 to generate similar embeddings (that are close to each other in the embedding space) for a pair of different training inputs that both have the same label, and to generate distinct embeddings (that are apart from each other in the embedding space) for different training inputs.

The semantic positive-based contrastive learning loss term can for example be computed as:

$${ℒ}_{S E M P O S} = - {\sum }_{m = 1}^{B} log \frac{φ ( {\hat{z}}_{m}^{{a}_{1}} , {\tilde{z}}_{m , t}^{{a}_{2} , +} )}{φ ( {\hat{z}}_{m}^{{a}_{1}} , {\tilde{z}}_{m , t}^{{a}_{2} , +} ) + {( {x}_{m} )}_{} φ ( {\hat{z}}_{m}^{{a}_{1}} , {\tilde{z}}_{n , t}^{{a}_{2}} )} ,$$

where

$${\overline{z}}_{m , t}^{{a}_{2} , +} ∼ U ( \{ ( {\overline{z}}_{l , t}^{{a}_{2}} , {y}_{l} ) ∈ Q \vert {y}_{l} = p l ( {x}_{m} ) \} )$$

represents the semantic positive sample for each training input xₘ within the batch B, where pl(xₘ)=yₘ if xₘ is a labeled training input and pl(xₘ)=y̅ₘ is xₘ is an unlabeled training input, with yₘ being the ground truth label and the bar notation indicating that it's a pseudo label.

When the optional augmentation-based contrastive learning loss term was not computed, the SEMPPL loss function can include just the semantic positive-based contrastive learning loss term.

Alternatively, when taking the two loss terms together, the SEMPPL loss function can for example be computed as:

$${ℒ}_{S E M P P L} = {ℒ}_{A U G M} + {αℒ}_{S E M P O S} ,$$

where α is a tunable hyperparameter that controls the ratio between the two loss terms. For example, a can take a value that is smaller than one, e.g., ⅕. Setting a to a value smaller than one accounts for the situations where, when computing the semantic positive-based contrastive learning loss term, some other training input within the batch might possibly have the same label as the training input 201.

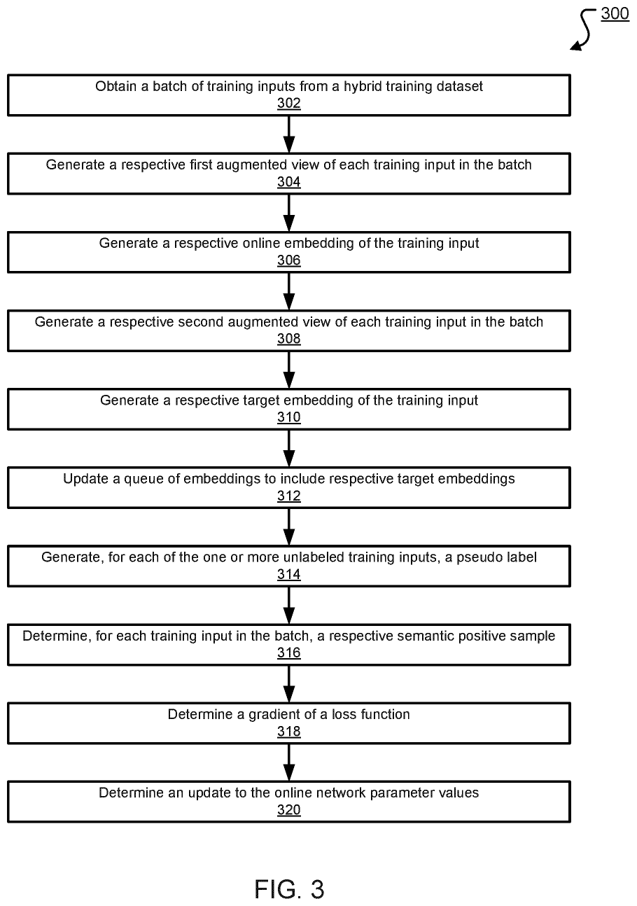

FIG. 3 is a flow diagram of an example process 300 for training an online neural network. For convenience, the process 300 will be described as being performed by a system of one or more computers located in one or more locations. For example, a training system, e.g., the training system 100 of FIG. 1, appropriately programmed, can perform the process 300.

The system obtains a batch of training inputs from a hybrid training dataset (step 302). The batch of training inputs, which can be obtained by randomly sampling from the hybrid training dataset, includes one or more unlabeled training inputs and one or more labeled training inputs. Each labeled training input is associated with a respective ground truth label.

The system generates a respective first augmented view of each training input in the batch (step 304). This can include sampling, with at least some measure of randomness, one or more augmentation policies from a set of augmentation policies, and then sequentially applying the one or more sampled augmentation policies to each training input in the batch.

The system generates, using the online neural network, a respective online embedding of each training input in the batch (step 306). The online neural network includes an online projection sub neural network and an online prediction sub neural network. For each training input, the online neural network is configured to process, in accordance with online network parameter values, the first augmented view of the training input to generate the online embedding.

The system generates a respective second augmented view of each training input in the batch (step 308). The system can do this by using a similar approach as described above at step 304. By virtue of the randomness in the sampling of the augmentation policies, the respective second augmented view will typically be different from the respective first augmented view for each training input in the batch.

The system generates, using the target neural network, a respective target embedding of each training input in the batch (step 310). The target neural network has the same network architecture as the online projection sub neural network but different parameter values. For each training input, the target neural network is configured to process, in accordance with target network parameter values, a second augmented view of the training input to generate the target embedding.

The system updates a queue of embeddings to include respective target embeddings generated by using the target neural network for the one or more labeled training inputs in the batch (step 312). For example, when implemented as a FIFO queue, the system can append the target embedding that has been generated for each labeled training input to the queue (potentially overwriting one or more already stored embeddings).

The system generates, for each of the one or more unlabeled training inputs in the batch, a pseudo label based on a measure of similarity between an online embedding of the unlabeled training input and each respective target embedding in the queue of embeddings (step 314). This can include using a k-nearest neighbors algorithm or a similar technique to determine k nearest embeddings of the unlabeled training input from the queue of embeddings, where k is a positive integer, and then generating the pseudo label for the unlabeled training input from the ground truth labels associated with the k nearest embeddings. In other words, the system determines which target embedding(s) are similar to the online embedding of each unlabeled training input and, because the similar target embedding(s) are each generated from a labeled training input, the system can use the ground truth labels associated those similar target embedding(s) to determine which pseudo label among a possible set of labels can be assigned to the unlabeled training input.

The system determines a respective semantic positive sample for each training input in the batch (step 316). This can include sampling, from the queue of embeddings and as the semantic positive sample, an embedding that has been generated for a labeled training input that has either the same pseudo label, or the same ground truth label, as the training input.

The system evaluates a SEMPPL loss function and determines a gradient of the SEMPPL loss function with respect to the online network parameter values (step 318).

The SEMPPL loss function includes a semantic positive-based contrastive learning loss term that encourages similarity between the respective online embedding and the respective semantic positive sample for each training input within the batch, but discourages similarity between the respective online embedding and target embedding that have been generated for different training inputs within the batch. Optionally, the SEMPPL loss function also includes an augmentation-based contrastive learning loss term that encourages similarity between the respective online embedding and target embedding that have been generated for each training input within the batch, but discourages similarity between the respective online embedding and target embedding that have been generated for different training inputs within the batch.

The system determines, based on the gradient of the SEMPPL loss function with respect to the online network parameter values, an update to the online network parameter values (step 320). The system can then determine the update by applying an optimizer to gradient, e.g., an Adam optimizer, an rmsProp optimizer, or a Layer-wise Adaptive Rate Scaling (LARS) optimizer, that is appropriate for the training of the online neural network.

The system can continue performing iterations of the process 300 to train the online neural network by repeatedly adjusting the online network parameter values until termination criteria for the training of the online neural network have been satisfied, e.g., until the parameters have converged, until a threshold amount of wall clock time has elapsed, or until a threshold number of iterations of the process 300 have been performed.

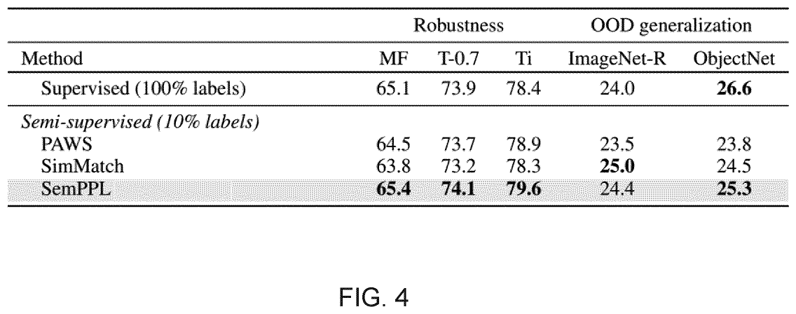

FIG. 4 shows a quantitative example of the performance gains that can be achieved by using the SEMPPL process described in this specification. In particular, FIG. 4 shows the Top-1 accuracy (in %, the higher the better) for images from ImageNetV2 (on its three variants: matched frequency (MF), Threshold 0.7 (T-0.7), and Top Images (TI), described in more detail in Benjamin Recht, et al. Do imagenet classifiers generalize to imagenet? In Proc. of International Conference on Machine Learning (ICML), 2019), ImageNet-R (described in more detail in Dan Hendrycks, et al. The many faces of robustness: A critical analysis of out-of distribution generalization. In Proceedings of the IEEE/CVF International Conference on Computer Vision, pp. 8340-8349, 2021), and ObjectNet (described in more detail in Andrei Barbu, et al. A large-scale bias-controlled dataset for pushing the limits of object recognition models. Proc. of Advances in Neural Information Processing Systems (NeurIPS), 2019).

It can be appreciated that, a neural network trained using the SEMPPL process generally has improved robustness and out-of-distribution generalization capabilities over a neural network trained using a PAWS process (described in more detail in Mahmoud Assran, et al. Semi-supervised learning of visual features by non-parametrically predicting view assignments with support samples. In Proc. of Conference on Computer Vision and Pattern Recognition (CVPR), 2021), a SimMatch process (described in more detail in Mingkai Zheng, et al. Simmatch: Semi-supervised learning with similarity matching. In Proc. of Conference on Computer Vision and Pattern Recognition (CVPR), 2022), or even a supervised baseline.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining a batch of training inputs from a hybrid training dataset, wherein the batch of training inputs comprises one or more unlabeled training inputs and one or more labeled training inputs, each labeled training input having a respective ground truth label;
generating a respective first augmented view of each training input in the batch;
processing, using an online neural network and in accordance with online network parameter values, the respective first augmented view of each training input to generate a respective online embedding of the training input;
generating a respective second augmented view of each training input in the batch, wherein, for each training input in the batch, the respective second augmented view is different from the respective first augmented view;
processing, using a target neural network and in accordance with target network parameter values, the respective second augmented view of each training input to generate a respective target embedding of the training input;
updating a queue of embeddings to include respective target embeddings generated by using the target neural network for the one or more labeled training inputs in the batch;
generating, for each of the one or more unlabeled training inputs in the batch, a pseudo label based on a measure of similarity between an online embedding of the unlabeled training input and each respective target embedding in the queue of embeddings;
determining, for each training input in the batch, a respective semantic positive sample, comprising
sampling, from the queue of embeddings and as the semantic positive sample, an embedding that has been generated for a labeled training input having the same pseudo label or the same ground truth label as the training input;
determining a gradient with respect to the online network parameter values of a loss function that includes a first term that encourages similarity between the respective online embedding and the respective semantic positive sample for each training input; and
determining, based on the gradient of the loss function with respect to the online network parameter values, an update to the online network parameter values.

2. The method of claim 1, wherein the loss function includes a second term that encourages similarity between the respective online and target embeddings for each training input.

3. The method of claim 1, wherein the online neural network comprises an online projection sub neural network and an online prediction sub neural network, the online projection sub neural network and the target neural network having a same network architecture but different parameter values.

4. The method of claim 3, wherein the target network parameter values are an exponential moving average of online projection sub network parameter values of the online projection sub neural network.

5. The method of claim 1, wherein the queue of embeddings has a fixed capacity which is dependent on a size of the batch of training inputs.

6. The method of claim 1, wherein the queue of embeddings includes respective target embeddings generated by using the target neural network for one or more labeled training inputs in a previously obtained batch.

7. The method of claim 1, wherein the training inputs comprise image data.

8. The method of claim 1, wherein the training inputs comprise audio data.

9. The method of claim 1, wherein generating the respective first augmented view of each training input in the batch comprise:
sampling one or more augmentation policies from a set of augmentation policies; and
sequentially applying the one or more sampled augmentation policies to each training input in the batch.

10. The method of claim 9, wherein the set of augmentation policies comprises a random cropping policy followed by resizing policy, a random color distortion policy, or a random Gaussian blur policy.

11. The method of claim 1, wherein generating, for each of the one or more unlabeled training inputs in the batch, the pseudo label comprises:
using a k-nearest neighbors model to determine k nearest embeddings of the unlabeled training input from the queue of embeddings, where k is a positive integer; and
generating the pseudo label for the unlabeled training input from the ground truth labels associated with the k nearest embeddings.

12. The method of claim 11, wherein k=1, and wherein the pseudo label is the same as the ground truth label associated with the determined nearest embedding.

13. The method of claim 11, wherein k>=2, and wherein the pseudo label is a highest occurring ground truth label among the determined nearest embeddings.

14. The method of claim 11, wherein the k-nearest neighbors model is configured to use cosine similarity to determine the k nearest embeddings of each unlabeled training input.

15. The method of claim 11, wherein generating, for each of the one or more unlabeled training inputs in the batch, the pseudo label comprises:
selecting, from among multiple k-nearest neighbors models that each correspond to a different augmentation policy, one or more k-nearest neighbors models; and
using each selected k-nearest neighbors model to determine k nearest embeddings of the unlabeled training input from the queue of embeddings.

16. The method of claim 1, wherein the hybrid training dataset comprises more unlabeled training inputs than labeled training inputs.

17. The method of claim 3, further comprising training a task sub neural network together with the online projection sub neural network to optimize a supervised, task-specific loss for a downstream task, wherein, for a training input from the hybrid training dataset, the task sub neural network is configured to process a projection embedding generated by the online projection sub neural network in accordance with task sub network parameter values to generate a downstream task output for the training input.

18. The method of claim 17, wherein the downstream task comprises a classification task, and wherein the supervised, task-specific loss comprises a cross-entropy loss.

19. A system comprising one or more computers and one or more storage devices storing instructions that are operable, when executed by the one or more computers, to cause the one or more computers to perform the operations of the respective method of any preceding claim operations comprising:
obtaining a batch of training inputs from a hybrid training dataset, wherein the batch of training inputs comprises one or more unlabeled training inputs and one or more labeled training inputs, each labeled training input having a respective ground truth label;
generating a respective first augmented view of each training input in the batch;
processing, using an online neural network and in accordance with online network parameter values, the respective first augmented view of each training input to generate a respective online embedding of the training input;
generating a respective second augmented view of each training input in the batch, wherein, for each training input in the batch, the respective second augmented view is different from the respective first augmented view;
processing, using a target neural network and in accordance with target network parameter values, the respective second augmented view of each training input to generate a respective target embedding of the training input;
updating a queue of embeddings to include respective target embeddings generated by using the target neural network for the one or more labeled training inputs in the batch;
generating, for each of the one or more unlabeled training inputs in the batch, a pseudo label based on a measure of similarity between an online embedding of the unlabeled training input and each respective target embedding in the queue of embeddings;
determining, for each training input in the batch, a respective semantic positive sample, comprising
sampling, from the queue of embeddings and as the semantic positive sample, an embedding that has been generated for a labeled training input having the same pseudo label or the same ground truth label as the training input;
determining a gradient with respect to the online network parameter values of a loss function that includes a first term that encourages similarity between the respective online embedding and the respective semantic positive sample for each training input; and
determining, based on the gradient of the loss function with respect to the online network parameter values, an update to the online network parameter values.

20. One or more non-transitory computer storage media encoded with instructions that, when executed by one or more computers, cause the one or more computers to perform operations comprising:
obtaining a batch of training inputs from a hybrid training dataset, wherein the batch of training inputs comprises one or more unlabeled training inputs and one or more labeled training inputs, each labeled training input having a respective ground truth label;
generating a respective first augmented view of each training input in the batch;
processing, using an online neural network and in accordance with online network parameter values, the respective first augmented view of each training input to generate a respective online embedding of the training input;
generating a respective second augmented view of each training input in the batch, wherein, for each training input in the batch, the respective second augmented view is different from the respective first augmented view;
processing, using a target neural network and in accordance with target network parameter values, the respective second augmented view of each training input to generate a respective target embedding of the training input;
updating a queue of embeddings to include respective target embeddings generated by using the target neural network for the one or more labeled training inputs in the batch;
generating, for each of the one or more unlabeled training inputs in the batch, a pseudo label based on a measure of similarity between an online embedding of the unlabeled training input and each respective target embedding in the queue of embeddings;
determining, for each training input in the batch, a respective semantic positive sample, comprising
sampling, from the queue of embeddings and as the semantic positive sample, an embedding that has been generated for a labeled training input having the same pseudo label or the same ground truth label as the training input;
determining a gradient with respect to the online network parameter values of a loss function that includes a first term that encourages similarity between the respective online embedding and the respective semantic positive sample for each training input; and
determining, based on the gradient of the loss function with respect to the online network parameter values, an update to the online network parameter values.

21. (canceled)
